(19) United States
(12) Patent Application Publication
(10) Pub. No.: US 2019/0348844 A1
(43) Pub. Date: Nov. 14, 2019

(54) DYNAMIC PULSE CHARGING SCHEME FOR SERIES-CONNECTED BATTERIES

(71) Applicant: Florida A&M University, Tallahassee, FL (US)

(72) Inventors: Pedro L. Moss, Tallahassee, FL (US); Mark H. Weatherspoon, Tallahassee, FL (US); Jamal F. Stephens, Tallahassee, FL (US)

(21) Appl. No.: 16/411,858

(22) Filed: May 14, 2019

Related U.S. Application Data
(60) Provisional application No. 62/700,496, filed on Jul. 19, 2018.
(60) Provisional application No. 62/671,171, filed on May 14, 2018.

(51) Int. Cl. H02J 7/00

(52) U.S. Cl. CPC H02J 7/0021

(57) ABSTRACT

A pulse charging topology for a battery management system and a method of independently charging batteries in series via pulse charging technology. The method uses pulse charging to independently charge a series-connected string of lithium batteries. The pulses can be adjusted to vary the average current induced into each of the batteries within a battery stack. Each battery is charged independently by using solid-state switches, controlled by a microcontroller unit that utilizes a pulse algorithm, which enables the batteries to simultaneously connect to a power bus and ground bus for a selective period. When any battery in the stack is fully charged, microcontroller detaches the charged battery from the system, allowing the uncharged batteries to continue charging. The pulse charging topology provides an efficient, light-weight, and compact mechanism, which offers isolation and bypassing capabilities, without the need for a transformer or any additional circuitry.

### CROSS-REFERENCE TO RELATED APPLICATIONS

This nonprovisional application is a continuation of and claims priority to provisional application No. 62/671,171, entitled “Dynamic pulse charging scheme for series-connected batteries,” filed May 14, 2018, by the same inventors, and is a continuation of and claims priority to provisional application No. 62/700,496, entitled “Dynamic pulse charging scheme for series-connected batteries,” filed Jul. 19, 2018, by the same inventors.

### FEDERALLY SPONSORED RESEARCH OR DEVELOPMENT

This invention was made with Government support under Grant. No. EEC-08212121 provided by the National Science Foundation. The government has certain rights in this invention.

### BACKGROUND OF THE INVENTION

### 1. Field of the Invention

This invention relates, generally, to charging series-connected batteries. More specifically, it relates to a dynamic current pulse charging scheme for series-connected batteries that can independently charge individual lithium-ion batteries within a stack, thereby improving the efficiency and performance of the stack.

### 2. Brief Description of the Prior Art

Lithium-ion batteries (LIBs) have presented numerous appealing advantages such as having a low self-discharge rate, long cycle life, no memory effect, broad temperature range of operation, high charge efficiency, and a higher operating voltage, as described in [1]-[5]. Although LIBs propose many significant and substantial characteristics for future applications, they also exhibit sporadic hazardous and unsafe disadvantages that could potentially lead to cell failure if the batteries are not operated within a safe and reliable range. Therefore, LIBs have safety limitations and boundaries that they must stay within, to optimize cell performance and expand the lifespan of the pack.

Lithium battery packs consist of multiple batteries connected in a series and/or parallel configuration to ensure that the pack can produce maximum power and energy to the load powered by the battery pack. Individually, these batteries can be maintained through careful observation; however, when these batteries are connected in series, it can create a significant problem of maintaining the optimum efficiency of all batteries in the pack due to the variations in each cell voltage, temperature and state of charge (SoC). This can also reduce battery efficiency and reduce the performance of the pack over time.

To prevent this problem and improve battery efficiency, a battery management system (BMS) is required to ensure that the batteries are safely monitored and protected from harsh conditions, particularly by monitoring battery voltage and temperature, and ensure that the batteries can operate under normal, safe operating conditions [6]-[8]. A BMS delivers a variety of features that execute specific tasks that increase the battery cycle life. One of the most important features of a BMS is the battery charge equalization circuit, which maximizes a battery's capacity to make all its energy available for use and at the same time expand the lifespan of the battery pack. Balancing of cells is a vital process and is required for any BMS. Balance can also be established from the differences in the batteries' SoC or voltage.

There are two types of balancing methods: passive and active balancing topologies, as described in [9]-[21]. Passive type topologies bleed (or dissipate) the excess energy from the battery with the highest voltage through the passive element, such as a resistor, until the voltages become equalized. Alternatively, active type topologies transfer charge from higher batteries to lower batteries via a form of control and the use of active elements, such as capacitors, inductors, and energy converters, which are used for energy storage. Active type topologies use, for example, complex control circuits that use solid state switches or transformers. Both methods perform battery balancing and carry certain advantages that can increase performance and long-term efficiency for the pack. In contrast, balancing circuits can be very complex and costly depending on the topology used. It can also increase the weight and bulkiness of the design, increasing the BMS size and cost for many applications, such as electric and hybrid electric vehicle battery packs. This can affect the overall performance of the pack and application over time.

LIB chargers are typically voltage-limiting type chargers or devices that must carefully adjust to avoid over-charging the battery. There are three main steps that lithium batteries must follow to prolong the battery life and performance. The three steps consist of inducing current into the battery, maintaining that current at steady level, and terminating or removing cell from charger when fully charged [22]. Depending on the characteristics of the battery (i.e. size and type) the charging profile will be adjusted to fit the specification for an efficient charge. It is extremely important that LIB chargers not exceed the battery limits, which can damage the battery and compromise safety.

The conventional way of charging lithium ion batteries is using a constant current-constant-voltage (CCCV) charge regime. This method consists of four separate stages; trickle charging, constant-current charging, constant-voltage charging, and charge termination, as described in [23]. The trickle charging procedure is usually performed to verify the status of the battery. To test whether the battery is operating in nominal conditions or has any presented symptoms of harm, trickle charge supplies a “low and slow” strategy that induces the battery with small charge current (about a tenth of the battery's capacity) until the battery proves itself suitable for charging, in which the battery will begin the constant-current stage. During the constant-current stage, the battery is charged with an adjustable charge voltage that maintains a specified level of current flow. A suitable charge rate at which lithium-ion batteries should be charged is in the range 0.5C-1 C, to ensure that lithium ion battery do not exceed its upper voltage limit. Upon completion of this phase, the battery is only about 80% to 85% of the total cell capacity. When the battery reaches its maximum voltage, the battery then is put into the constant-voltage stage. In this stage, the battery voltage is held at its maximum threshold while the charge current decreases exponentially to about 3-5% of the batteries capacity. At this point, the battery is considered to be fully charged, and the charge is terminated. The combined methods exhibit the best efficiency in comparison with other charging methods and is used in most battery chargers today.

Alternatively, batteries may be charged via pulse charging by feeding current or voltage into batteries for a short period of time, as shown in FIGS. 1A-1B. Pulse charging uses a transistor in series with the supply and the battery and in some cases between the battery and a reference point as well. The transistor acts like a switch that opens and closes to provide power to each battery selectively. The pulses are precisely controlled by varying the duty cycle for a specific switching period which is based on the average current, as described in [24]. The average current can be expressed by equation (1):

$${I}_{avg} = \frac{1}{T} {\int }_{0}^{T} {I}_{p} ( t ) dt \qquad ( 1 )$$

where I_{avg} is the average current of the pulse, T is the switching period, and Iₚ(t) is the pulse current induced into the battery. This method is flexible with the pulse switching period. To obtain the correct average current, the duty cycle (the pulse width) must be calculated. Equation (1) can be rearranged and the pulse duration given as equation (2):

$$Δ t = \frac{{I}_{avg} \cdot T}{I} \qquad ( 2 )$$

where Δt is the duration of on-time of the pulse. The duty cycle is inversely proportional to the switching period. Therefore, the duty cycle, denoted by D, can be calculated using equation (3):

$$D = \frac{Δ t}{T} \qquad ( 3 )$$

Studies have claimed that this method of charging can reduce the surface film growth on the electrode, which is one of the primary causes of battery failure. Reduction of film growth also lowers the impedance (discharges the capacitive reactance), allowing subsequent charge pulses to enter into the battery more efficiently [25], [26]. This potentially can increase the battery's discharge capacity, effectively increasing the battery's life span. Pulse charging is said to have a lower charge time compared to the CCCV methods described above. This is due to the short relaxation periods that the battery undergoes during charging. This produces a quasi-equilibrium state during the charge process, which will then result in lower overpotential of the concentration [27]. Accordingly, the battery can reach full charge, eliminating the need for a constant voltage stage. Pulse charging improves the active material utilization, allowing for a more efficient flow of charges to and from cathodic and anodic electrodes. According to [28], the comparison between pulse charging and CCCV methods are very similar in terms of the temperature, capacity reduction and efficiency. As a result, pulse charging is an alternative option for charging LIBs.

However, typical pulse charging methods do not provide ways to independently charge individual batteries connected in series to achieve charge equalization. Accordingly, what is needed is an efficient current pulse charge topology that can independently charge LIBs that are connected in series. However, in view of the art considered as a whole at the time the present invention was made, it was not obvious to those of ordinary skill in the field of this invention how the shortcomings of the prior art could be overcome.

### BRIEF SUMMARY OF THE INVENTION

The long-standing but heretofore unfulfilled need for a pulse charging topology that allows for the independent charging of individual batteries within a battery stack is now met by a new, useful, and nonobvious invention.

The novel structure includes a current source, a switching network, and a microcontroller unit. The current source provides constant current to a power bus and a ground bus, which are electrically connected to the switching network. The switching network is also in electrical communication with a plurality of batteries within a battery stack, with a plurality of gates being disposed between the switching network and the battery stack. Each gate includes a pair of switches, with the gates being adapted to control current flow into the battery stack via the status of the switches-if the switches are connected, current can flow to the battery, and vice versa. The microcontroller unit is in electrical communication with the battery stack via the switching network, with the microcontroller unit being adapted to independently transmit pulses of current into each of the plurality of batteries. In addition, the microcontroller unit is adapted to determine a charge for each of the batteries, compare the determined charges to predetermined maximum charge capacities for each battery, and disconnect the switching network from individual batteries when they reach the predetermined maximum charge capacities. Accordingly, the microcontroller unit disconnects the switching network from the entire battery stack when each of the plurality of batteries reaches the predetermined maximum charge capacity, indicating that the battery stack is fully charged.

An object of the invention is to provide an efficient charging topology and method of charging a plurality of batteries connected in-series that allows for the independent charging of individual batteries, thereby improving charging capabilities and limiting power loss.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1A is an example of a prior art pulse charging system.

FIG. 1B is a representation how a batter is charged via a typical pulse charging system.

FIG. 1C is an example of a typical battery management system including a plurality of batteries

FIG. 2A is an overview of a dynamic pulse charging circuit, in accordance with an embodiment of the current invention.

FIG. 2B is a schematic of a dynamic pulse charging circuit for series-connected batteries, in accordance with an embodiment of the current invention.

FIG. 3 is a flowchart of a method of charging a stack of series-connected batteries, in accordance with an embodiment of the current invention.

FIG. 4 is a schematic representation of the current source, in accordance with an embodiment of the current invention.

FIG. 5A is a schematic representation of the current path for a first battery in a battery pack.

FIG. 5B is a schematic representation of the current path for a second battery in a battery pack.

FIG. 5C is a schematic representation of the current path for a third battery in a battery pack.

FIG. 6 is a graph of the control pulses for each Gate of a dynamic pulse charging circuit.

FIG. 7A is a graphical comparison of two methods of charging different batteries, with one charging method being constant current, and the other being dynamic pulse charging.

FIG. 7B is a graphical comparison of two methods of charging different batteries, with one charging method being constant current, and the other being dynamic pulse charging.

FIG. 7C is a graphical comparison of two methods of charging different batteries, with one charging method being constant current, and the other being dynamic pulse charging.

FIG. 8A is a graphical representation of the time needed to reach different given battery charges using a dynamic pulse charging system.

FIG. 8B is a graphical representation of the time needed to reach different given battery charges using a dynamic pulse charging system.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized and structural changes may be made without departing from the scope of the invention.

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

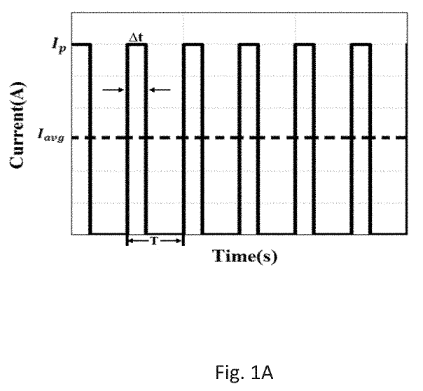

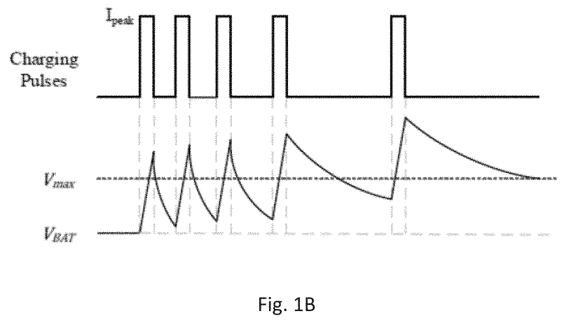

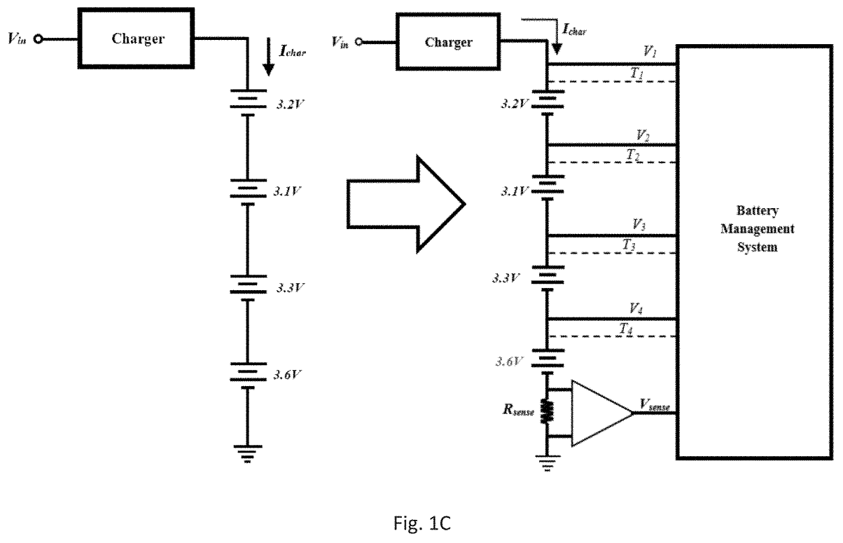

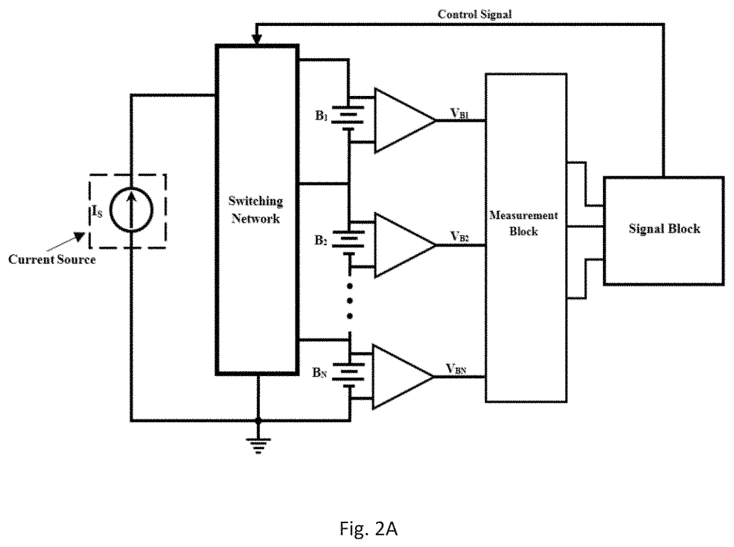

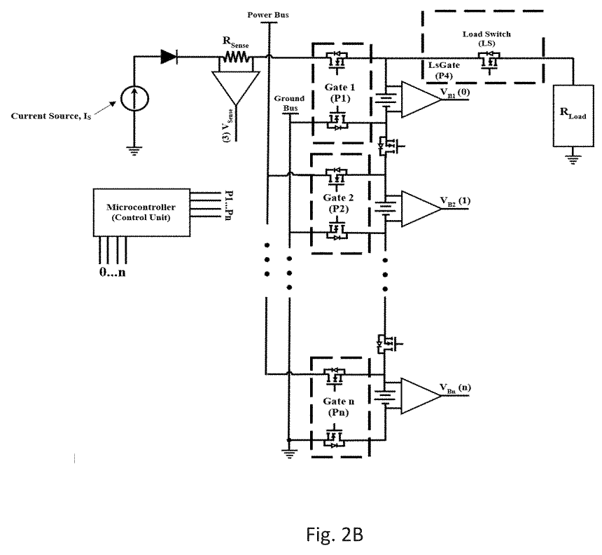

The present invention includes a pulse charging topology for a battery management system and a method of independently charging batteries in series via pulse charging technology. A typical battery management system is depicted in FIG. 1C, showing how current can be diverted to a series of batteries within a battery management system. The method (an overview of which is depicted in FIG. 2A) is modeled after the typical battery management system of FIG. 1C; however, the method uses pulse charging to charge a series-connected string of lithium batteries. The pulses can be easily adjusted by varying the duty cycle and switching period, which affects the average current induced into the battery. For example, constant voltage in each battery can be achieved by reducing the duty cycle (pulse width) as the maximum voltage of the battery is approached—this allows each battery to receive its own independent charge, increasing the equalization rate and increasing the efficiency of the battery stack.

In addition, each battery is charged independently by using solid-state switches, controlled by a simple pulse algorithm that enables the batteries to connect to a power and ground bus simultaneously for a selective period. When any battery in the stack is fully charged, a control unit detaches the battery from the system, allowing the rest of the batteries to also reach their maximum potential. The system provides a light-weight and compact design, and offers isolation and bypassing capabilities, without the need of a transformer or any additional circuitry. Accordingly, the present invention includes a control strategy for the pulse charging topology, while also providing the batteries with proper care to prevent from over-charging and discharging to prolong battery life.

As shown in FIG. 2B, the pulse equalization topology includes three main features: a current source, a microcontroller (control unit), and a switching network that interconnects batteries to the source. In this configuration, the current source provides a stable constant current that is fed into a power and ground buses. The source current is fixed; however, it can be adjusted to the desired current of choice. Connected to the two buses is the switching network, to which each battery is connected. The network is comprised of 2n+(n−1) switches, where n is the number of batteries in the system. Each pair of switches (comprised of metal-oxide-semiconductor field-effect transistors, or MOFSET) connected to the battery is referred to as a “gate”. Both the power and ground switch gates are connected, which denotes that they must simultaneously be turned on to have current flow through the battery. Switches are also included in-between each battery for isolation and are configured in such a way that protects the batteries from opposite flow of current. No battery will have any effect on another battery while charging, which significantly improves the efficiency.

The orientation of the body diode inside all gates is also crucial, in terms of the efficiency of the circuitry. The body diodes must be positioned in such a way that current is only allowed to flow through and from the battery when notified to do so. All body diodes connected to the power bus must be configured in reverse bias to stop the source from flowing into the battery; however, all body diodes connected to the ground bus must be configured in forward bias to block the current flow from the battery—these steps occur during a rest period. When one or all batteries reach full charge, the control unit will detach the batteries from the charger, close any switches between the batteries in the stack, and connect a load using the load switch, if any load is available.

An essential component of this scheme is the microcontroller unit (MCU). The MCU has the responsibility of not only controlling the switches, but also protection for the batteries in the stack. A simple observation of the proposed charger algorithm is illustrated by the flowchart in FIG. 3. Before the batteries undergo any operation, the status of each must first be verified that all are functioning inside their nominal conditions. This is a voltage-based design; therefore, the sequence of pulses depends on the stack voltage and the individual voltages of the batteries. If any of the batteries are lower than the minimum or higher than the maximum thresholds, the charger will have to reset or transmit a fault signal indicating cell failure. This demonstrates a sense of precaution, as it reads each battery voltage independently before executing a task. This form of protection provides a means of locating faulty batteries and increasing efficiency throughout the entire stack. After declaring the status of the battery, if suitable, the batteries will then proceed to the pulse charging stage. Using the above equations, the batteries will pulse charge independently at this stage until the stack's maximum threshold is met. Any battery in the stack that is not fully charged will continue to charge, while the batteries that are fully charged rest. Finally, when all batteries meet the threshold that ends, the pulse charging process and the stack waits for further instruction.

Results

The hardware test was done to test the behavior and performance of this system. Three 1.1 Ah LiFePO₄ (APR18650M1A) batteries from A123Systems was chosen for this design. Specification of the battery can be seen in Table I.

TABLE I
Battery Characteristics of LiFePO₄ Battery

| Battery Type | LiFePO₄ | |
|---|---|---|
| Nominal Capacity | 1000 | mAh |
| Nominal Voltage | 3.3 | V |
| Max Charge Voltage | 3.65 | V |
| Cutoff Voltage | 2.0 | V |
| Cycle Life | <2000 | cycles |
| Core Cell Weight | 39 | g |

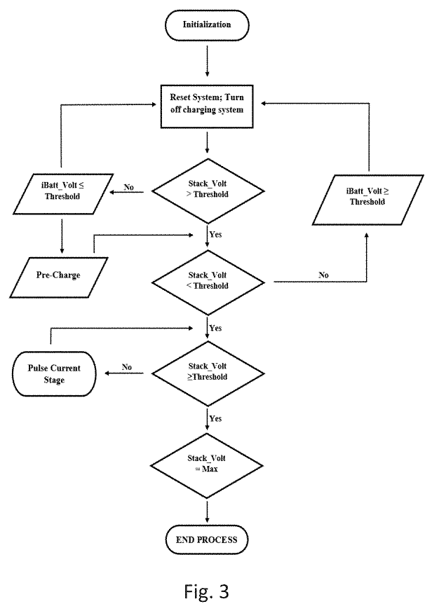

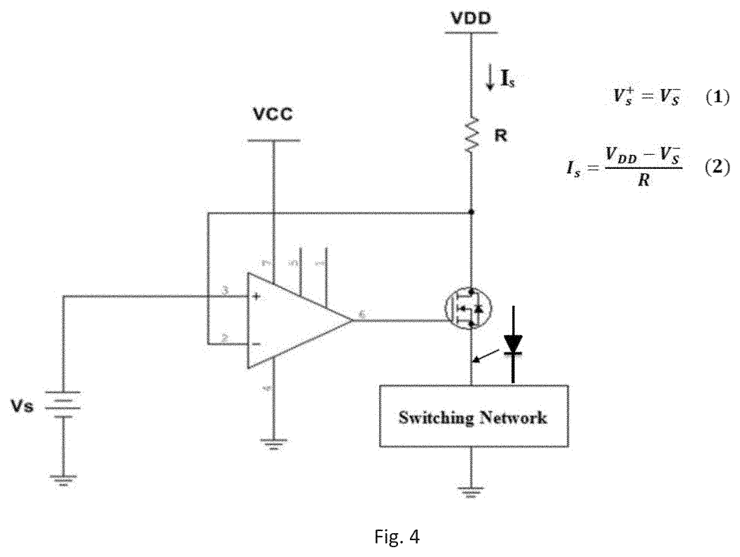

Table II provides the components and a description of each that were used in the hardware implementation. The current source was designed to supply a maximum current of 1 A (about 1C) (the current source is depicted in FIG. 4). Being that this design is voltage-based, the voltage of the battery must be accurately measured to ensure an efficient control; to avoid accelerated degradation, the voltage range of each battery was limited to 2.0 V to 3.65 V. The Arduino® UNO unit was used as the control unit of the design. This MCU can only accept voltages that range from 0-5V with a ±200 mV error reading. In this system, batteries are not always directly connected to a reference. This can vary the input voltage readings; therefore, each battery is connected to an instrumentation op-amp that measures the voltage difference between the positive and negative terminals of the batteries with minimum error. Accuracy is a significant asset to know when the switches need to start charging and stop charging. To conduct the switches, the gate voltage needed to be higher than the threshold voltage of the MOSFET and the battery voltage, which was calculated to be about 7.65 V. The Arduino® unit provided a maximum pulse width modulation (PWM) of 5 V, hence, the need for a gate driver. The gate drivers helped push the voltage to the point where the MOSFET would allow current to flow through.

TABLE II
Component List of Proposed Topology

| Part Number | Item Description |
|---|---|
| LM386 | Op-amp; used as a voltage |
| | follower |
| AD8451 | Op-amp; used to implement |
| | the current source |
| UCC27425 | Gate driver; used to drive the |
| | gate of the switches |
| IRF530 | NMOS; n-channel MOSFET |
| AD8226 | Instrumentation amplifier; |
| | used as a voltage sensor |
| ARDUINO ® UNO | Microcontroller; used as a |
| | protection unit and as a |
| | control unit to control the |
| | switches |

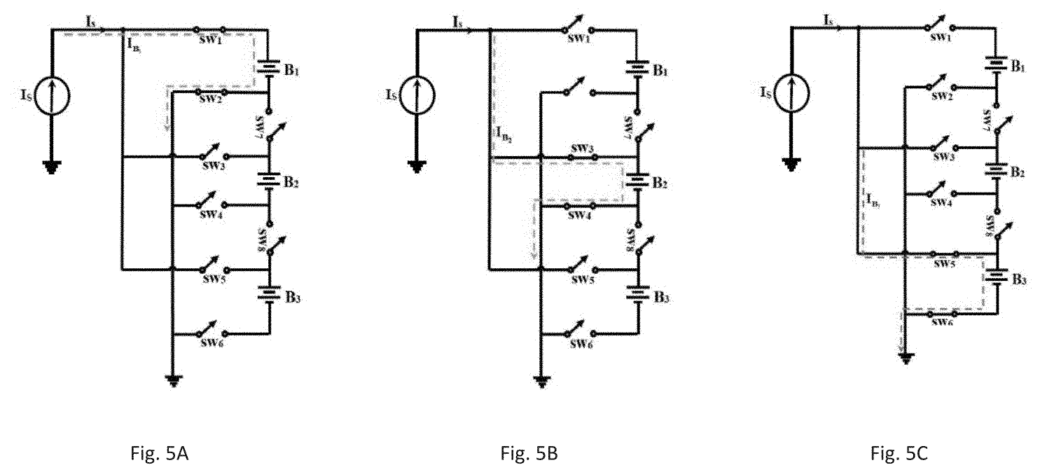

The current path for various switching positions are shown in FIGS. 5A, 5B, and 5C. The BMS drives each battery to full charge using four consecutive steps, and the state of charge of each battery is initialized and summarized in Table 111.

TABLE III
Battery State of Charge for Two Cases

| Battery | Case 1 (SOC %) | Case 2 (SOC %) |
|---|---|---|
| B₁ | 50 | 30 |
| B₂ | 60 | 52 |
| B₃ | 70 | 85 |

In these steps, the MCU gives a logic high or low to cell switches, and simultaneously connects and/or disconnects battery B, to the power and ground nodes. In step 1, during charging, the BMS voltage monitoring circuit recognizes that battery B₁ in the stack is uncharged. Therefore, the MCU sends a signal to connect switch SW₁ to the power bus and switch SW₂ to the ground bus for 50 ms. As shown in FIG. 5A, current I_{B}_{₁} flows starting from the current source, through B₁, and into the ground node. If, during the time period, the battery voltage reaches the maximum charge voltage, battery B₁ is removed from the charge sequence.

In step 2, after the complete turn-off of cell switches SW₁ and SW₂, the monitoring circuit determines the charge status of battery B₂. If B₂ is below the maximum voltage, switches SW₃ and SW₄ are turned on by the MCU for 50 ms. As a result, the current path is constructed as shown in FIG. 5B.

In step 3, after switches SW₃ and SW₄ are turned off, and if battery B₃ is uncharged, switches SW₅ and SW₆ are turned on by the MCU. The current path for battery B₃ is constructed in FIG. 5C.

In step 4, when the status of all cells have reached the maximum charge voltage, the process charge is terminated.

Experimental Results

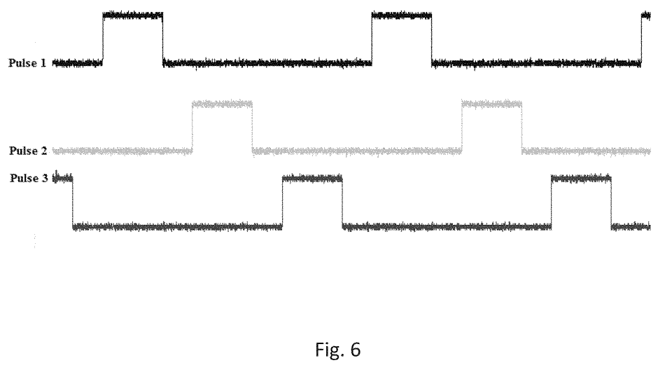

The switching period was controlled to influence the source current induced in each battery by ⅓ of the period. As a result, the average current that the batteries would be charged by is ⅓ C (0.333 A). FIG. 6 illustrates the control pulses generated using the UNO.

The pulses were configured to have an on-time of 250 ms and an off-time of 50 ms, which makes the total period 300 ms. The illustration also shows the sequence of the pulses. To ensure that the batteries charge with the smallest time of interruption, the pulses are about 50 ms and 100 ms apart, with respect from the initial pulse, thereby giving the previous pulse enough time to shutoff before the next begins. Pulses should not be produced at the same time, because if the control unit turns on two Gates at similar periods, the positive terminal of that battery will be connected directly to ground, causing the battery to short.

To test the performance of the topology, each battery was discharged to about 2.1 V (about 0% SoC). To verify that the average current of 0.333 A is produced, a constant-current charge of 0.333 A was applied to each battery (separately) for three hours, using the VersaSTAT 4 as a test bed and data logger. Next, the process of discharging the batteries to the same voltage was repeated, then the proposed pulse charging circuit was applied on each battery.

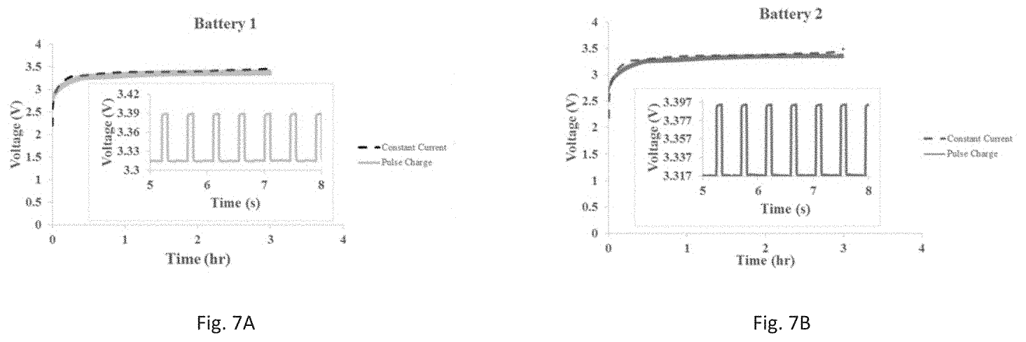

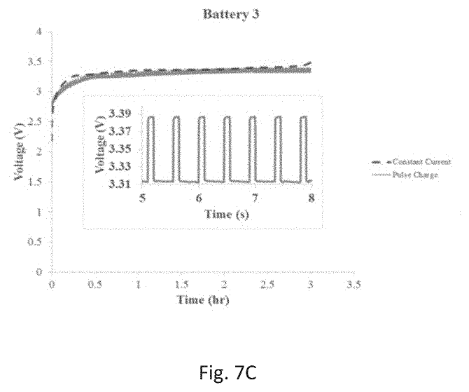

FIGS. 7A-C show the comparison of the two different methods—the pulse charging method and the constant-current method. As FIGS. 7A-6C show, the pulse charging circuit follows the charging profile of the constant-current method, starting with battery 1 and ending with battery 3. Each plot also provides a graphical representation that all batteries were charged with the average current of about ⅓ C. Each battery follows the correct pulse that it is associated with, with a small delay in-between each start, indicating “make before break”. Although the constant-current method does not fall in the middle of the pulse charged profile, it exhibits that the following topology can charge these batteries independently in a series configuration. Those small deviation can also come from the losses the circuit undergoes during the start process. The power loss through the circuit is govern by equation (4):

P_{Loss}=(V_{D}·Iₛ)+2RₒₙIₚ²+Iₚ²Rₛₑₙₛₑ (4)

where V_{D} is the diode voltage, Iₛ is the peak current of the external current source, Rₒₙ is the internal resistance of the MOSFET, and Rₛₑₙₛₑ is the resistance of the sensor resistor (a constant value of 10 mΩ). The total power loss of an individual battery was found to be about 0.925 Mw. Using a three-battery system, the total power loss was about 1.27 W. This presents an efficient amount of power being induced into a single battery at a time.

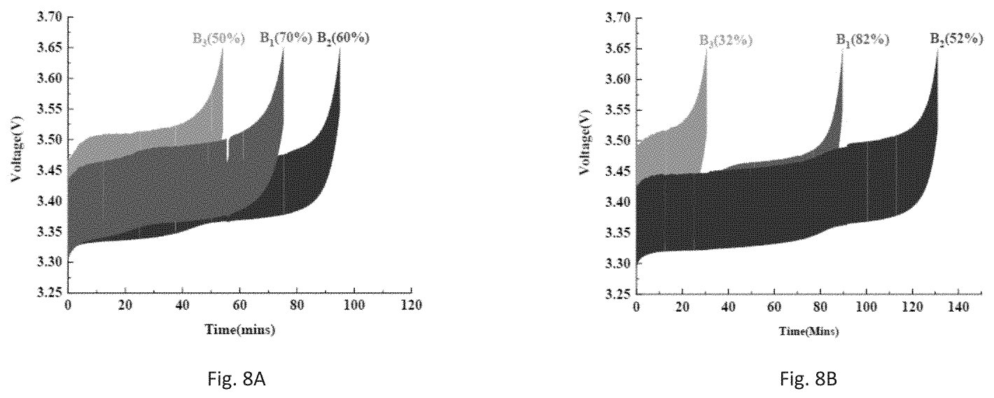

In a battery pack, all batteries would not be at the same voltage level or SoC, as they were in the example of FIGS. 7A-C. The full capability of the dynamic pulse charging method can be seen in FIGS. 8A and 8B, which graphically depict two scenarios in which each battery was charged to a different SoC using the Arbin Instrument BT2000 as a test bed and data logger. Each battery was then connected to the dynamic pulse charging circuit to completely be charged. In both cases, each battery was capable of fully charging without the need of a balancing circuit, a distinct advantage of the pulse charging method. FIGS. 8A-B also show the independence of each gate, with each gate shutting down as soon as the individual battery reaches its maximum potential, thereby allowing the other batteries to continue charging with no disruption.

Each battery was discharged to two initial SOCs, and subsequently charged to a maximum voltage of 3.65 V, using a pule charge current. In both cases, each battery was capable of fully charging without the need for complex balancing circuitry to guarantee full charge of each battery. The battery voltages before and after charge are shown in Table IV.

TABLE IV
Voltage Distribution from Beginning of Charge to End of Charge

| | Case 1 (Voltage) | | Case 2 (Voltage) | |
|---|---|---|---|---|
| Battery | Begin | End | Begin | End |
| B₁ | 3.47 | 3.65 | 3.40 | 3.65 |
| B₂ | 3.30 | 3.65 | 3.34 | 3.65 |
| B₃ | 3.31 | 3.65 | 3.29 | 3.65 |

In addition, this scheme allows for a better way to obtain the SoC. By knowing the nominal capacity of the battery and the initial SoC, an estimated SoC can be obtain by using either the interval pulse current or the average current during the battery maximum charge time. This also is illustrated by equation (5):

$$SoC = SoC ( {t}_{0} ) + \frac{η ( t )}{Q} {\int }_{{t}_{0}}^{t} i ( t ) dt \qquad ( 5 )$$

where SoC(t₀) is the initial SoC, Q is the nominal capacity of the battery of choice, η(t) is the coulombic efficiency of the battery, and i(t) is the charge/discharge current induced into the battery. The expression is also valid for the polarity of the charge/discharge currents to be positive during a charge, and negative during a discharge.

The proposed switching network demonstrated as expected by providing isolation while charging and was also able to deliver power to each battery. A hardware design was also implemented to examine the effects and behavior of the proposed topology. Overall, the topology performed as expected and isolated each battery, and most importantly charged batteries independently. Not only did the topology demonstrated individual battery charge, the results above indicate that the dynamic pulse charge topology provides a resolution for charging series connected cells. In addition, the topology removes the need for complex and bulky cell balancing circuitry, and allows for the efficient simultaneous charging of batteries within a stack using a constant voltage charge delivered in pulses.

### Glossary of Claim Terms

Battery stack: is a set of interconnected individual battery cells.

Maximum charge capacity: is the greatest amount of energy that can be stored in a battery.

Microcontroller unit: is a computer on a single integrated circuit.

Switching network: is a plurality of electrical components that interrupt or divert electrical current from flowing between conductors.

### REFERENCES

[1] Nitta, Naoki, Feixiang Wu, Jung Tae Lee, and Gleb Yushin. “Li-ion Battery Materials: Present and Future.” Elsevier 18. (2015): 252-64.
[2] Tarascon, J M., and M Armand. “Issues and Challenges Facing Rechargeable Lithium Batteries.” Macmillian Magazines Ltd 15 Nov. 2001: 359-69.
[3] Li, Zhihua, Duanming Zhang, and Fengxia Yang. “Developments of Lithium-ion Batteries and Challenges of LiFePO4 as One Promising Cathode Material.” Journal of Material Science 44. (2009): 2435-43.
[4] Scrosati, Bruno, and Jurgen Garche. “Lithium Batteries: Status, Prospects and Future.” Journal of Power Sources 195 (2010): 2419-30.
[5] Oswal, Meshul, Jason Paul, and Runhua Zhao. “A Comparative Study of Lithiumlon Batteries.” (2010): 1-28.
[6] Andrea, Davide. Battery Management Systems for Large Lithium-Ion Battery Packs. Norwood: ARTECH HOUSE, 2010.
[7] Cheng, K. W. E., B P. Divakar, Hongjie Wu, Kai Ding, and Ho Fai Ho. “Battery-Management System (BMS) and SoC Development for Electric Vehicles.” IEEE Transactions 60.1 (2011): 76-88.
[8] Yan, Xiangwu, Wei Li, Jiancheng Gu, and Xiangning Xiao. “A Simulated System of Battery-Management-System to Test Electric Vehicles Charger.” IEEE (2012).
[9] Daowd, Mohamed, Noshin Omar, Peter Van Den Bossche, and Joeri Van Mierlo. “Passive and Active Battery Balancing Comparison Based on MATLAB Simulation.” IEEE Xplore (2011).
[10] Pascual, Cesar, and Philip T. Krein. “Switched Capacitor Systems for Automatic Series Battery Equalization.” IEEE (1997).
[11] Ye, Yuanmao, and Ka Wai Eric Cheng. “An Automatic Switch-Capacitor Cell Balancing Circuit for Series-Connected Battery Strings.” Energies 9.138 (2016): 1-15.
[12] Daowd, Mohamed, Mailier Antoine, Noshin Omar, Philippe Lataire, Peter Van Den Bossche, and Joeri Van Mierlo. “Battery Management System-Balancing Modularization Based on a Single Switched Capacitor and Bi-Directional DC/DC Converter with Auxiliary Battery.” Energies 7. (2014): 2897-937.
[13] Kim, Chol-Ho, Hong-Sun Park, Chong-Eun Kim, Gun-Woo Moon, and Joong-Hui Lee. “Individual Charge Equalization Converter with Parallel Primary Windings of Transformer for Series Connected Lithium-Ion Battery Strings in an Hybrid Electric Vehicle (HEV).” Journal of Power Electronics 9.3 (2009): 472-80.
[14] Park, Kyung-Hwa, Chol-Ho Kim, Hee-Keun Cho, and Joung-Ki Seo. “Design Considerations of a Lithium Ion Battery Management System (BMS) for the STSAT-3 Satellite.” Journal of Power Electronics 10.2 (2010): 210-17.
[15] Xu, Jun, Siqi Li, Chris Mi, Zheng Chen, and Binggang Cao. “SoC Based Battery Cell Balancing with a Novel Topology and Reduced Component Count.” Energies 6. (2013): 2726-40.
[16] Chang, Yong-Nong, Yu-Siang Shen, Hung-Liang Cheng, and Shun-Yu Chan. “The Optimized Capacity for Lithium Battery Balancing Charging/Discharging Strategy.” IEEE Xplore (2014).
[17] Camara, M. B., F Gustin, H Gualous, and A Berthon. “Energy Management Strategy for Coupling Supercapacitors and Batteries with DC-DC Converters for Hybrid Vehicle Applications.” IEEE Xplore (2008): 1542-47.
[18] Caricchi, F, F Crescimbini, F Giulii Capponi, and L Solero. “Study of Bi-Directional Buck-Boost Converter Topologies for Application in Electrical Vehicle Motor Drives.” IEEE (1998): 287-93.
[19] Hong, Wei, Kong-Soon Ng, Jin-Hsin Hu, and Chin-Sien Moo. “Charge Equalization of Battery Power Modules in Series.” IEEE (2010): 1568-72.
[20] Bentley, W F. “Cell Balancing Considerations for Lithium-Ion Battery Systems.” IEEE (1997): 223-26.
[21] Cao, Jian, Nigel Schofield, and Al Emadi. “Battery Balancing Methods: A Comprehensive Review.” IEEE (2008).
[22] Linden, David, and Thomas B. Reddy. Handbook of Batteries. 3 ed. New York: McGraw-Hill, 2002.
[23] Tar, Bora, and Ayman Fayed. “An Overview of the Fundamentals of Battery Chargers.” IEEE 59th International Midwest Symposium on Circuits and Systems (MWSCAS) (2016).
[24] Yin, Meng Di, Jeonghun Cho, and Daejin Park. “Pulse-Based Fast Battery IoT Charger Using Dynamic Frequency and Duty Control Techniques Based on MultiSensing of Polarization Curve.” Energies (2016): 1-20.
[25] Li, Jun, Edward Murphy, Jack Winnick, and Paul A. Kohl. “The Effects of Pulse Charging on Cycling Characteristics of Commercial Lithium-ion Batteries.” Journal of Power Sources 102. (2001): 302-09.
[26] Liang, T. J., T Wen, K. C. Tseng, and J. F. Chen. “Implementation of a Regenerative Pulse Charger Using Hybrid Buck-Boost Convereter.” IEEE (2001): 437-42.
[27] Gaddes, Daniel W. The Effects of Pulsed Charging on Lithium Ion Batteries. Georgia Institute of Technology, 2016.
[28] Beh, Hui Zhi Zak, Grant A. Covic, and John T. Boys. “Effects of Pulse and DC Charging on Lithium Iron Phosphate (LiFePO4) Batteries.” Effects of Pulse and DC Charging on Lithium Iron Phosphate (LiFePO4) Batteries. N.p., n.d. Web. 15 Nov. 2016.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

1. A pulse charging topology comprising:
a current source that provides a current to a power bus and a ground bus;
a switching network in electrical communication with each of the power bus and the ground bus, the switching network including a plurality of gates, each gate including a pair of switches, with each of the plurality of gates being in communication with one of a plurality of batteries in a battery stack; and
a microcontroller unit in electrical communication with the battery stack via the switching network, the microcontroller unit adapted to:
independently transmit pulses of current into each of the plurality of batteries;
determine a charge of each of the plurality of batteries in the battery stack;
compare the determined charges with predetermined maximum charge capacities for each of the plurality of batteries; and
disconnect the switching network from the battery stack when each of the plurality of batteries reaches the predetermined maximum charge capacity.

2. The pulse charging topology of claim 1, wherein at least one of the plurality of gates further comprises a body diode electrically coupled to the power bus, the body diode configured in reverse bias to prevent the current from flowing into the one of the plurality of batteries that is in communication with the selected one of the plurality of gates during a resting period.

3. The pulse charging topology of claim 1, wherein at least one of the plurality of gates further comprises a body diode electrically coupled to the ground bus, the body diode configured in forward bias to prevent the current from flowing out of the one of the plurality of batteries that is in communication with the selected one of the plurality of gates during a resting period.

4. The pulse charge topology of claim 1, wherein each of the plurality of batteries is a lithium battery.

5. A method of charging a battery stack, the method comprising the steps of:
providing a battery stack including a plurality of batteries connected in series, each of the plurality of batteries including a power gate and a ground gate, each power gate electrically coupled to each ground gate on each of the plurality of batteries in the battery stack;
electrically connecting the battery stack to each of a power bus and a ground bus by electrically connecting the power bus to each of the power gates and electrically connecting the ground bus to each of the ground gates; and
charging the battery stack by feeding current into the battery stack by transmitting a source current through each of the power bus and the ground bus into each of the plurality of batteries in the battery stack,
wherein the source current is transmitted to each of the plurality of batteries via a sequence of pulses, thereby pulse charging the battery stack.

6. The method of claim 5, further comprising the step of positioning a body diode of each power gate such that the body diode is configured in reverse bias, such that at least one of the power gates is configured to block the source current from flowing into the associated at least one of the plurality of batteries during a non-charging period.

7. The method of claim 5, further comprising the step of positioning a body diode of each ground gate such that the body diode is configured in forward bias, such that at least one of the ground gates is configured to prevent a charge from flowing out of the associated at least one of the plurality of batteries during a non-charging period.

8. The method of claim 5, wherein the sequence of pulses is determined by a duty cycle based on the source current.

9. The method of claim 5, wherein each of the plurality of batteries in the battery stack simultaneously and independently receives the source current, such that each of the plurality of batteries charges simultaneously.

10. The method of claim 5, further comprising the step of electrically disconnecting at least one of the plurality of batteries from each of the power bus and the ground bus upon a determination that the at least of the plurality of batteries has reached a maximum charging threshold.

11. The method of claim 5, wherein the step of charging the battery stack terminates upon a determination that each of the plurality of batteries has reached a maximum charging threshold.
